(19) United States
(12) Patent Application Publication
(10) Pub. No.: US 2016/0049808 A1
(43) Pub. Date: Feb. 18, 2016

(54) BATTERY CHARGING AND DISCHARGING OF SINGLE SWITCH AND CONTROL METHOD THEREFOR

(71) Applicant: Silergy Semiconductor Technology (Hangzhou) LTD, Hangzhou (CN)

(72) Inventor: Wei Chen, Saratoga, CA (US)

(21) Appl. No.: 14/822,012

(22) Filed: Aug. 10, 2015

(30) Foreign Application Priority Data
Aug. 12, 2014 (CN) 201410393234.7

(51) Int. Cl. H02J 7/00

(52) U.S. Cl. CPC H02J 7/008; H02J 7/0029; H02J 7/0063; H02J 7/0052; H02J 7/0047; H02J 2007/0067

(57) ABSTRACT

A battery charging and discharging circuit can include: (i) a power switch coupled between the first and second connection ports, where the first connection port is coupled to an external unit and the second connection port is coupled to a rechargeable battery; (ii) where when the first connection port is coupled to an input power supply, energy from the input power supply is provided for storage in the rechargeable battery by controlling the power switch; (iii) where when the first connection port is coupled to a load, the energy stored in the rechargeable battery is provided to the load by controlling the power switch; and (iv) where the power switch includes a bi-directional blocking transistor.

### RELATED APPLICATIONS

This application claims the benefit of Chinese Patent Application No. 201410393234.7, filed on Aug. 12, 2014, which is incorporated herein by reference in its entirety.

### FIELD OF THE INVENTION

The present invention generally relates to the field of semiconductors/electronics, and more particularly to a battery charging and discharging circuit of a single switch, and an associated control method.

### BACKGROUND

In a conventional battery charging management system, at least two switches are typically required for controlling power transmission during a charging and discharging process of a battery. FIG. 1 shows a schematic diagram of one example conventional battery charging and discharging management system. During the charging process, switches Q1 and Q2 are controlled so as to provide input energy V_{PWR} to battery Batt. During the discharging process, switches Q1 and Q2 and a switch in the voltage regulator are controlled so as to transmit the energy stored in battery Batt to a load at Vout. In addition, the output power of the charging and discharging circuit should be regulated in order to meet various requirements of different loads. Thus, the entire circuit may have a relative complex structure due to control of a plurality of switches. As a result, power loss and circuit volume may be increased.

### SUMMARY

In one embodiment, a battery charging and discharging circuit can include: (i) a power switch coupled between the first and second connection ports, where the first connection port is coupled to an external unit and the second connection port is coupled to a rechargeable battery; (ii) where when the first connection port is coupled to an input power supply, energy from the input power supply is provided for storage in the rechargeable battery by controlling the power switch; (iii) where when the first connection port is coupled to a load, the energy stored in the rechargeable battery is provided to the load by controlling the power switch; and (iv) where the power switch includes a bi-directional blocking transistor.

In one embodiment, a method of controlling a battery charging and discharging circuit can include: (i) providing energy from an input power supply for storage in a rechargeable battery by controlling a power switch when a first connection port is coupled to the input power supply, where the power switch is coupled between the first connection port and a second connection ports, and where the second connection port is coupled to the rechargeable battery; and (ii) providing the energy stored in the rechargeable battery to a load by controlling the power switch when the first connection port is coupled to a load, where the power switch includes a bi-directional blocking transistor.

### BRIEF DESCRIPTION OF THE DRAWINGS

FIG. 1 is a schematic block diagram of an example conventional battery charging and discharging management system.

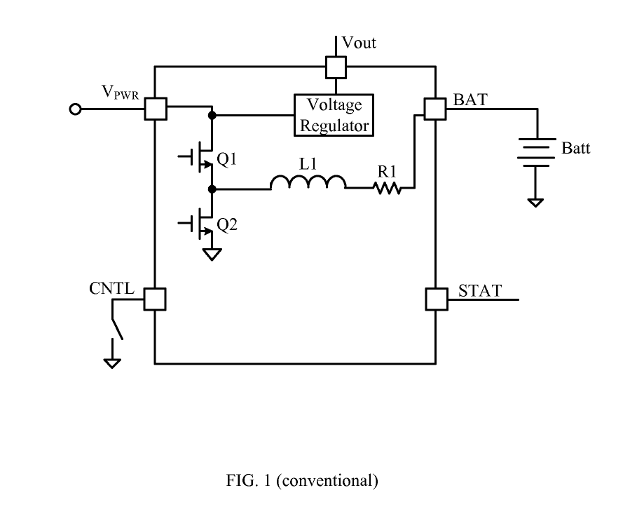

FIG. 2 is a schematic block diagram of a first example battery charging and discharging circuit, in accordance with embodiments of the present invention.

FIG. 3A is a schematic block diagram of a second example battery charging and discharging circuit, in accordance with embodiments of the present invention.

FIG. 3B is an example power switch used in an example battery charging and discharging circuit, in accordance with embodiments of the present invention.

FIG. 4 is a schematic block diagram of a third example battery charging and discharging circuit, in accordance with embodiments of the present invention.

FIG. 5 is a schematic block diagram of an example discharging control circuit of the example of FIG. 4, in accordance with embodiments of the present invention.

FIG. 6 is a flow diagram of an example method of controlling battery charging and discharging, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

In one embodiment, a battery charging and discharging circuit can include: (i) a power switch coupled between the first and second connection ports, where the first connection port is coupled to an external unit and the second connection port is coupled to a rechargeable battery; (ii) where when the first connection port is coupled to an input power supply, energy from the input power supply is provided for storage in the rechargeable battery by controlling the power switch; (iii) where when the first connection port is coupled to a load, the energy stored in the rechargeable battery is provided to the load by controlling the power switch; and (iv) where the power switch includes a bi-directional blocking transistor.

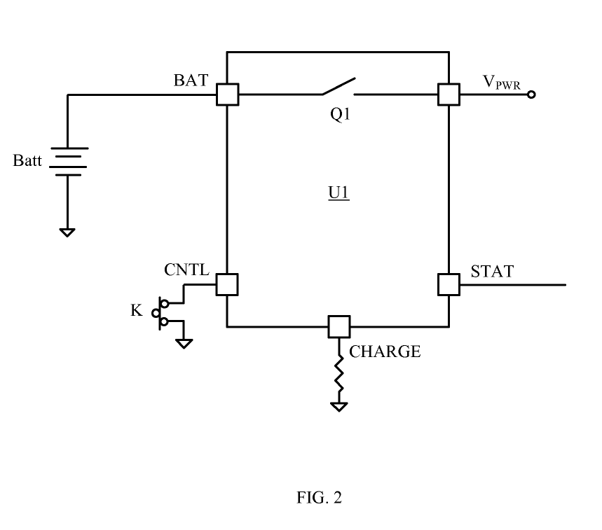

Referring now to FIG. 2, shown is a schematic block diagram of a first example battery charging and discharging circuit, in accordance with embodiments of the present invention. This particular battery charging and discharging circuit can include connection port V_{PWR} for coupling to an external unit, and connection port BAT for coupling to a rechargeable battery. Power switch Q1 can connect between connection port V_{PWR} and connection port BAT. When connection port V_{PWR} connects to an input power supply, energy from the input power supply can be provided to charge the battery by controlling the switching states of the power switch. When connection port V_{PWR} is connected to a load, the energy stored in the battery may be transmitted to the load by controlling the switching state of the power switch. For example, power switch Q1 can be a bi-directional block switch, whereby the direction of a parasitic diode of the power switch can change when the battery switches between the charging process and the discharging process.

For example, the battery charging and discharging circuit can also include connection port STAT for coupling to a charging indication circuit, connection port CHARGE for receiving a charging control signal, and a connection port CNTL for receiving a discharge control signal. The battery charging and discharging circuit as shown herein is implemented by an integrated circuit U1, and the connection ports are shown as pins of integrated circuit U1. In particular embodiments, the battery charging and discharging circuit may include a single power switch Q1. During the charging and discharging processes of the battery, the power switch can be controlled (e.g., turn off/on). In this way, complexity of the overall control circuit and the power device can be reduced as compared to conventional approaches.

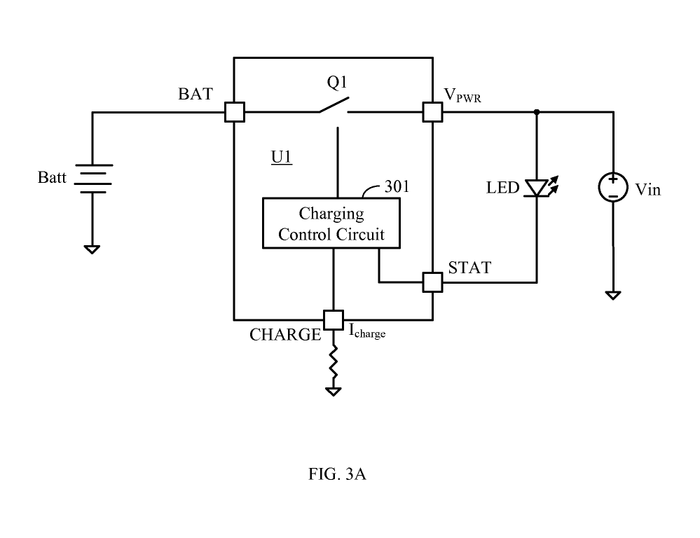

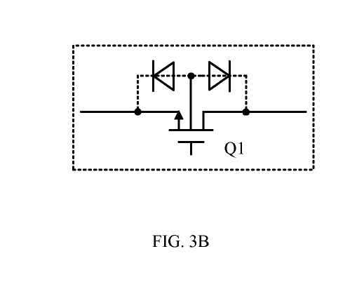

Referring now to FIG. 3A, shown is a schematic block diagram of a second example battery charging and discharging circuit, in accordance with embodiments of the present invention. In this particular example, connection port V_{PWR} can connect to input power supply Vin, and connection port BAT can connect to rechargeable battery Batt. Thus, the energy from input power supply Vin may be provided to, and stored in, rechargeable battery Batt, as part of the charging process of battery “Batt.” Also, power switch Q1 can connect between connection port V_{PWR} and connection port BAT. As shown in FIG. 3B, the power switch can be configured as a transistor with adjustable source-drain configurations. In this particular example, the source of the power switch can connect to connection port BAT, and the drain can connect to connection port V_{PWR}, so as to prevent energy from the rechargeable battery from feeding to the input power supply during the charging process. Furthermore, in this example, the battery charging and discharging circuit can control the switching state of power switch Q1 through charging control circuit 301, in order to transmit the energy.

In addition, the example battery charging and discharging circuit can include connection port STAT and a charging indication circuit. For example, the charging indication circuit can include a light-emitting diode (LED) light having an anode coupled to connection port V_{PWR}, and a cathode coupled to connection port STAT. In this configuration, the state of the LED light can indicate if the battery is in the charging process and is fully charged. For example, the LED light may flash to represent that the battery is in the charging process, and the LED light may turn green represents that the battery is fully charged. Of course, the LED light can alternatively or additionally be used to represent other states in certain embodiments.

Generally, in the charging process of the battery, the charging current can be set as a fixed value (e.g., about 400 mA). However, in some certain cases, the charging current may be set in a range of from about 200 mA to about 600 mA. In such a case, the battery charging and discharging circuit can also include connection port CHARGE for receiving charging current control signal I_{charge}, so as to set the charging current of the battery according to charging current control signal I_{charge}. Also as shown, connection ports STAT and CHARGE can connect to charging control circuit 301, in order to control and regulate control signals via charging control circuit 301.

During the charging process of the battery, in order to avoid the damage to the integrated circuit caused by various factors (e.g., overheat, overcurrent, etc.), charging control circuit 301 may also be included with suitable protection functions (e.g., over-temperature, overvoltage, overcurrent, etc.). For example, the temperature of the integrated circuit (IC) can be monitored, and if the IC temperature exceeds a predetermined threshold temperature, the charging current may be reduced in order to lower associated power losses, and such that the circuit operates in a safe temperature range. Also for example, when the charging current of the battery is determined by monitoring to be greater than a predetermined threshold current, the charging current of the battery may be reduced in order to avoid overvoltage and/or overcurrent.

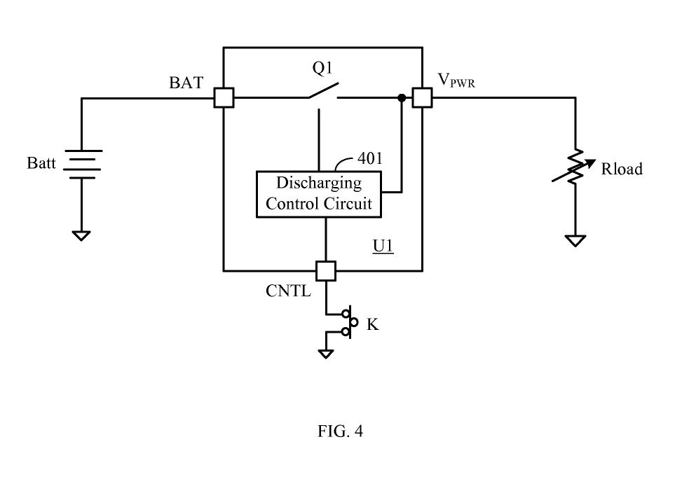

Referring now to FIG. 4, shown is a schematic block diagram of a third example battery charging and discharging circuit, in accordance with embodiments of the present invention. In this particular example, connection port V_{PWR} can connect to load Rload, and connection port BAT can connect to battery Batt. Thus, the circuit shown in this example may transmit energy from battery Batt to load Rload in the discharging process of battery Batt. In this example, the power switch may be a transistor with an adjustable source and drain, as shown in FIG. 3B. For example, the drain of the power switch can connect to connection port BAT, and the source can connect to connection port V_{PWR}, in order to prevent energy at the load terminal from feeding to the battery during the discharging process. For example, the battery charging and discharging circuit can control the switching state of power switch Q1 through discharging control circuit 401, in order to appropriately transmit the energy.

This example charging and discharging circuit can also include connection port CNTL for receiving a discharging control signal, where the charging and discharging control signal is represented by setting an external key-press K. For example, key-press K may be pressed to represent that the battery is starting to be discharged. Also for example, if key-press K is pressed continuously for several times, it can mean that the output power is to be regulated to a given value. In one case, there may be five predetermined power states, whereby the power state changes when the key-press is continuously pressed for, e.g., three times, and then to proceed by repeating the operation.

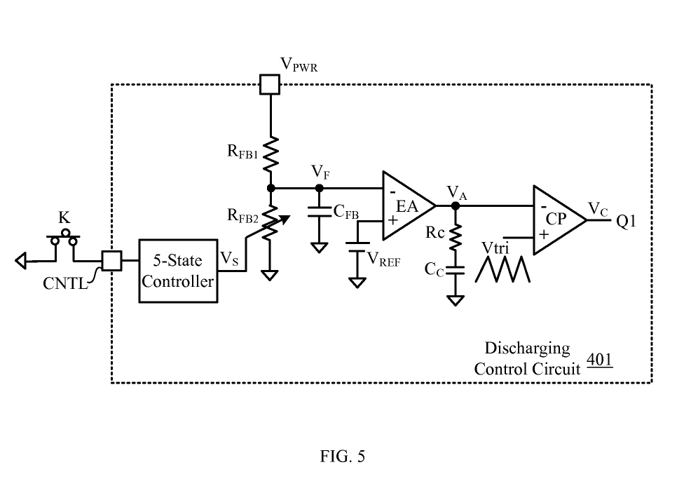

Referring now to FIG. 5, shown is a schematic block diagram of an example discharging control circuit of the example of FIG. 4, in accordance with embodiments of the present invention. In this example, discharging control circuit 401 can include an operation state controller, an output voltage feedback circuit, an error amplifier, and a comparison circuit. As shown, the operation state controller can be configured as the 5-state controller, may receive the discharging control signal, and may generate state control signal V_{S}.

The output voltage feedback circuit can include a bleeder loop including resistors R_{FB1} and R_{FB2}, and filter capacitor C_{FB}. For example, resistor R_{FB2} can be an adjustable resistor. Also the output voltage feedback circuit can receive an output voltage signal via connection port V_{PWR}, and state control signal V_{S}, and may generate feedback signal V_{F} of the output voltage average value. The feedback signal of the output voltage average value can change when state control signal V_{S} is different. For example, state control signal V_{S} can control the value of resistor R_{FB2}, so as to regulate feedback signal V_{F} of the output voltage average value.

The error amplifier circuit can include error amplifier EA and a compensation circuit including resistor R_{C} and capacitor C_{C}. Error amplifier EA may have an inverting input terminal for receiving feedback signal V_{F} of the output voltage average value, and a non-inverting input terminal for receiving reference voltage signal V_{REF}. Error amplifier EA may generate an error signal by an error calculation, and the error signal may be configured as compensation signal V_{A} via the compensation circuit. The comparison circuit can include comparator CP having an inverting input terminal for receiving compensation signal V_{A}, and a non-inverting input for receiving sawtooth signal Vtri. Comparator CP can generate switching control signal V_{C}, which can control the switching state of power switch Q1.

When key-press K is off, it can indicate that there is no load, and power switch Q1 can remain off. When key-press K is pressed, it can indicate that the load power at the output terminal should be regulated according to the setting of the 5-state controller. For example, a corresponding power value can be set to be a full load of 100%, and the remaining can be set as 90%, 85%, 80% and 75% of the power value of the full load. Further, the power may be changed in sequence when the key-press is repeatedly pressed, such as for every three times. In the example circuit of FIG. 5, when the load power is regulated to 90% from 100%, the key-press K may be continuously pressed for, e.g., three times. In this case, state control signal V_{S} can accordingly change, and the value of resistor R_{FB2} may be reduced. Thus, feedback signal V_{F} of the output voltage average value may be reduced, and the duty cycle of power switch Q1 can be reduced by switching control signal V_{C} via error circuit EA and comparison circuit CP. As a result, the output voltage signal at connection port V_{PWR} may be accordingly reduced in order to regulate the output power.

In certain embodiments, the period of sawtooth signal Vtri may be less than a predetermined value such that the output voltage feedback circuit can obtain a relatively smooth feedback signal of an output voltage average value. Due to volume requirements of integrated circuit U1, filter capacitor C_{FB} may be relatively small, and the frequency of the output voltage signal at connection port V_{PWR} should be high enough to obtain a relatively smooth feedback signal of the output voltage average value. Therefore, the period of sawtooth signal Vtri may be less than the predetermined value, in order to ensure that the switching frequency of power switch Q1 is high enough to obtain a relatively smooth feedback signal of the output voltage average value.

Discharging control circuit 401 can include an operation state controller, an output voltage feedback circuit, and error circuit and a comparison circuit. In one very particular example, the output voltage feedback circuit may not receive state control signal V_{S}, and instead error circuit EA may directly receive state control signal V_{S}. Specifically, the reference voltage signal can change when the state control signal is different. For example, the reference voltage signal may be provided by a reference voltage signal generator that changes the reference voltage signal according to state control signal V_{S}. As those skilled in the art will recognize, when the reference voltage signal is changed to something different, the duty cycle of the switching control signal of power switch Q1 may accordingly be changed. Therefore, the output voltage signal of connection port V_{PWR} can accordingly be different in order to regulate the output power.

During the discharging process, a stable output electric signal may be obtained by controlling the output voltage average value. As those skilled in the art will recognize, the output electrical signal can be controlled by loop control of the output current average value or the output power average value. In addition, during the discharging process of the battery, if the discharge current of the battery is higher than a predetermined threshold current, the discharge current may be reduced in order to protect the battery. Also, during the discharging process, the temperature of the integrated circuit can be monitored. When the temperature exceeds a predetermined threshold temperature, power losses may be reduced by reducing the discharging current such that the circuit may operate within a safe temperature range.

In the above described battery charging and discharging circuit, only one power switch may be controlled during the charging and discharging processes of the battery, in order to reduce the complexity of the control circuit and the power device. In the charging process of the battery, the charging current can be customized according to particular application requirements. In the discharging process, the output voltage average value can be controlled in order to maintain the stability of an output signal. In this way, power losses of the system can be reduced, and the circuit volume may be optimized.

In particular embodiments, battery charging and discharging circuit of a single switch can be used in bi-directional charging and discharging applications, such as in the control of an electronic cigarette or a movable power source. In addition, while charging control circuit 301 and discharging control circuit 401 have been shown and described as two separate control circuits, those skilled in the art will recognize that these two separate control circuits can alternatively be integrated into one charging and discharging control circuit.

In one embodiment, a method of controlling a battery charging and discharging circuit can include: (i) providing energy from an input power supply for storage in a rechargeable battery by controlling a power switch when a first connection port is coupled to the input power supply, where the power switch is coupled between the first connection port and a second connection ports, and where the second connection port is coupled to the rechargeable battery; and (ii) providing the energy stored in the rechargeable battery to a load by controlling the power switch when the first connection port is coupled to a load, where the power switch comprises a bi-directional blocking transistor.

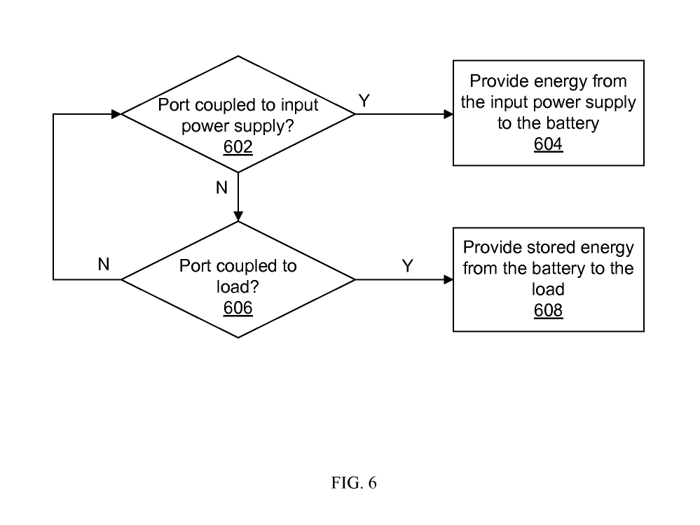

Referring now to FIG. 6, shown is a flow diagram of an example method of controlling battery charging and discharging, in accordance with embodiments of the present invention. At 602, it can be determined whether a connection port (e.g., V_{PWR}) is coupled to an input power supply. If so, at 604, energy can be provided or otherwise transmitted from the input power supply for storage in the battery by controlling a power switch (e.g., Q1). This can represent a charging process for the battery. Also, the power switch can be coupled between first and second connection ports (e.g., V_{PWR} and BAT), and the second connection port can be coupled to the battery. Furthermore, during the process of transmitting the energy from the input power supply to the rechargeable battery, the charging current of the rechargeable battery may be a fixed value, or can be set to be an appropriate value by an external programming circuit.

At 606, it can be determined whether a connection port (e.g., V_{PWR}) is coupled to a load. If so, at 608, the energy stored in the rechargeable battery can be provided or otherwise transmitted to a load by controlling the power switch. This can represent a discharging process for the battery. Further, the power switch can include a bi-directional blocking transistor. In addition, during the process of transmitting the energy stored in the rechargeable battery to the load, the output voltage can be regulated by controlling the output voltage average value.

The embodiments were chosen and described in order to best explain the principles of the invention and its practical applications, to thereby enable others skilled in the art to best utilize the invention and various embodiments with modifications as are suited to the particular use contemplated. It is intended that the scope of the invention be defined by the claims appended hereto and their equivalents.

What is claimed is:

1. A battery charging and discharging circuit, comprising:
a) a power switch coupled between said first and second connection ports, wherein said first connection port is coupled to an external unit and said second connection port is coupled to a rechargeable battery;
b) wherein when said first connection port is coupled to an input power supply, energy from said input power supply is provided for storage in said rechargeable battery by controlling said power switch;
c) wherein when said first connection port is coupled to a load, said energy stored in said rechargeable battery is provided to said load by controlling said power switch; and
d) wherein said power switch comprises a bi-directional blocking transistor.

2. The battery charging and discharging circuit of claim 1, further comprising:
a) a third connection port; and
b) a charging indication circuit coupled between said first and third connection ports, and being configured to indicate if the rechargeable battery is in a charging process or if said rechargeable battery is fully charged when said first connection port is coupled to said input power supply.

3. The battery charging and discharging circuit of claim 2, further comprising a fourth connection port configured to receive a charging current control signal that sets a charging current of said rechargeable battery, wherein said charging current control signal is provided by an external programming circuit.

4. The battery charging and discharging circuit of claim 1, further comprising:
a) a fifth connection port; and
b) a discharging control circuit configured to provide a discharging control signal via said fifth connection port, wherein said discharging control signal is represented by setting an external key-press.

5. The battery charging and discharging circuit of claim 4, wherein said discharging control circuit comprises:
a) an operation state controller configured to receive said discharging control signal, and to generate a state control signal;
b) an output voltage feedback circuit configured to receive an output voltage signal at said first connection port and said state control signal, and to generate a feedback signal of said output voltage average value that changes when said state control signal changes;
c) a first error circuit configured to receive said feedback signal and a reference voltage signal, and to generate a first error signal;
d) a compensation circuit configured to compensate said first error signal to generate a first compensation signal; and
e) a first comparison circuit configured to receive said first compensation signal and a sawtooth signal, and to generate a switching control signal to control said power switch.

6. The battery charging and discharging circuit of claim 5, wherein a period of said sawtooth signal is less than a predetermined value such that said feedback signal is relatively smooth.

7. The battery charging and discharging circuit of claim 4, wherein said discharging control circuit comprises:
a) an operation state controller configured to receive said discharging control signal, and to generate a state control signal;
b) an output voltage feedback circuit configured to receive an output voltage signal at said first connection port, and to generate a feedback signal of an output voltage average value;
c) a first error circuit configured to receive said feedback signal and a reference voltage signal, and to generate a first error signal, wherein said reference voltage signal changes when said state control signal changes;
d) a compensation circuit configured to compensate said first error signal to generate a first compensation signal; and
e) a first comparison circuit configured to receive said first compensation signal and a sawtooth signal, and to generate a switching control signal to control said power switch.

8. A method of controlling a battery charging and discharging circuit, the method comprising:
a) providing energy from an input power supply for storage in a rechargeable battery by controlling a power switch when a first connection port is coupled to said input power supply, wherein said power switch is coupled between said first connection port and a second connection ports, and wherein said second connection port is coupled to said rechargeable battery; and
b) providing said energy stored in said rechargeable battery to a load by controlling said power switch when said first connection port is coupled to a load, wherein said power switch comprises a bi-directional blocking transistor.

9. The method of claim 8, further comprising setting, by an external programming circuit, a charging current of said rechargeable battery when said energy is being provided to said rechargeable battery.

10. The method of claim 8, regulating an output electrical signal by controlling an output voltage average value when said energy is provided to said load.

11. The method of claim 10, wherein said regulating said output electrical signal comprises:
a) receiving a discharging control signal, and generating a state control signal;
b) receiving an output voltage signal at said first connection port and said state control signal, and generating a feedback signal of said output voltage average value that changes when said state control signal changes;
c) receiving said feedback signal and a reference voltage signal, and generating a first error signal;
d) compensating said first error signal to generate a first compensation signal; and
e) receiving said first compensation signal and a sawtooth signal, and generating a switching control signal for controlling said power switch.

12. The method of claim 10, wherein said regulating said output electrical signal comprises:
a) receiving a discharging control signal, and generating a state control signal;
b) receiving said output voltage signal at said first connection port and said state control signal, and generating a feedback signal of said output voltage average value;
c) receiving said feedback signal and a reference voltage signal, and generating a first error signal, wherein said reference voltage signal changes when said state control signal changes;
d) compensating said first error signal to generate a first compensation signal; and
e) receiving said first compensation signal and a sawtooth signal, and generating a switching control signal for controlling said power switch.

13. The method of claim 11, wherein a period of said sawtooth signal is less than a predetermined value such that said feedback signal is relatively smooth.
